(19) United States
(12) Patent Application Publication
(10) Pub. No.: US 2015/0280598 A1
(43) Pub. Date: Oct. 1, 2015

(54) Apparatus and method of Automated Power Saving and Safety

(71) Applicants: Nissim Zur, Givataim (IL); Eli Arad, Tzofit (IL)

(72) Inventors: Nissim Zur, Givataim (IL); Eli Arad, Tzofit (IL)

(21) Appl. No.: 14/675,855

(22) Filed: Apr. 1, 2015

Related U.S. Application Data
(60) Provisional application No. 61/973,291, filed on Apr. 1, 2014.

(51) Int. Cl. H02M 5/293

(52) U.S. Cl. CPC H02M 5/293

(57) ABSTRACT

A power regulator that may include a power input for receiving input power; a power output for outputting output power; a sensing module for sensing an occurrence of a first event; and a controller that is configured to control a provision of input power to the power output in response to the occurrence of the first event; wherein the sensing module comprises a proximity sensor and the first event is an absence of any person within a first predefined range from to the power regulator; and wherein the controller is configured to reduce the output power when the first event occurs.

### RELATED APPLICATION

This patent application claims the priority of U.S. Provisional Patent Ser. No. 61/973,291 filing date Apr. 1, 2014 which is incorporated herein by reference in its entirety.

### FIELD OF THE INVENTION

The disclosed invention is related to the field of electronics, and in particular to providing a human radiant energy sensing control apparatus and method for automated power safety and saving features of an electronic device based on detection of a user's human radiant energy.

### BACKGROUND

Each year, about 4,000 injuries associated with electrical outlets are treated in U.S. emergency rooms every year, says the U.S. Consumer Product Safety Commission. About ⅓ of these occur when kids looking to explore insert metal objects like keys, tweezers, hairpins, or their wet little fingers into the outlets. Severe burns and death often ensues. There are over 100 children who die every year in the United States after this accidental electrocution.

Many residential fires are caused by overheating of extension cords. The U.S. Consumer Product Safety Commission estimates that about 4,700 residential fires originate in extension cords each year, killing 50 persons and injuring some 280 others.

Overheating of extension cords can occur at the plug, at the socket, or over the entire length of the cord. Hot plugs and sockets are often caused by deteriorated connections to the cord wires.

Blue sparks are often generated upon plugging or unplugging an appliance into the power socket. These sparks carbonize the contacting copper plates and may eventually lead to a possible fire if overheated.

A normal power strip outlet can withstand 5,000 cycles of plug and unplug. This disclosed embodiments invention circuits can do 4 times as much. That's 20,000 times, if electric cord unplug three times a day, the outlet can last for 18 years.

Many residential fires are caused by overheating of extension cords. The U.S. Consumer Product Safety Commission estimates that about 4,700 residential fires originate in extension cords each year, killing 50 persons and injuring some 280 others.

Overheating of extension cords can occur at the plug, at the socket, or over the entire length of the cord. Hot plugs and sockets are often caused by temperature deteriorated connections to the cord wires.

### SUMMARY

Embodiments of the disclosed invention includes a human radiant energy sensing control apparatus and method for automating power saving features of an electronic device based on detection of a user's human radiant energy. For example, in one embodiment, an electric power socket is disclosed having a sensitive wireless capabilities to detect nearby human, carry devices with wireless channel open, as smart phone, tablets etc. When no nearby strong wireless energy is detected, as happens where there is no human, the APS—Automatic Power Saver and Safety embedded in electric power socket disconnects the power to the appliance connected to that electric power socket. In other embodiments the APS method invention capabilities is embedded in other wireless enabling devices, as light bulb, door locker, TVs, and all other home and office appliances. APS devices has capabilities of sensing human body heat and human carry wireless devices, is also disclosed the safety method of disconnect the mains power from the electric power socket on detection human hand nearby. The APS device can be configured over its wireless channel for enabling a user to configure one or more functions associated with the power “on” and “off” triggered in response to detecting the presence or absence of the user within the proximity to the APS device or the approaching of the human hand to a APS device.

This disclosed embodiments invention circuits help prevent these tragic accidents from happening. The patented design ensures that electric power may only be conducted when a proper plug is 100% inserted into the outlet.

This disclosed embodiments invention circuits detect water presence. And disconnect the flow of electricity when water detected. This allows machines that one have plugged in to keep working while protected from being electrocuted by wet plug.

This disclosed embodiments invention circuits prevent blue sparks from happening. Its algorithms and current measurement prevents carbon from building up and overheating, this keeping the home safe.

This disclosed embodiments invention circuits comes with an AC surge suppressor that discontinues any flow of electric power when temperature reaches high values, thus preventing fire caused by overloading.

According to an embodiment of the invention there may be provided a power regulator that may include a power input for receiving input power; a power output for outputting output power; a sensing module for sensing an occurrence of a first event; and a controller that may be configured to control a provision of input power to the power output in response to the occurrence of the first event; wherein the sensing module may include a proximity sensor and the first event may be an absence of any person within a first predefined range from to the power regulator; and wherein the controller may be configured to reduce the output power when the first event occurs.

The proximity module may be configured to sense radiation emitted from a person or a device of the person.

The sensing module may be further configured to sense an occurrence of a second event, and the controller may be configured to control the provision of input power to the power output in response to the occurrence of the second event that differs from the first event.

The sensing module may include a current monitor and wherein the second event may be a change in an electrical parameter of an output current provided through the power output that exceeds a predefined current change threshold.

The electrical parameter may be an increment rate of the output current.

The sensing module may include a thermal monitor and wherein the second event may be an increase of a temperature of the power regulator that exceeds a predefined temperature threshold.

The sensing module may include a power monitor for monitoring a consumption of the output power to provide power monitoring results; wherein the power regulator may include a transceiver for transmitting information about the power monitoring results.

The sensing module may include a humidity monitor for monitoring a humidity in proximity to the power output; wherein the second event may be a humidity that exceeds a predefined level.

The controller may be configured to limit an increment rate of the output current during a powering up of a device that may be coupled to the power output.

The controller may be configured to suppress sparks by modulating the output power.

The power regulator may include a transceiver for receiving instructions that define the first event.

### BRIEF DESCRIPTION OF THE DRAWINGS

Illustrative embodiments of the present invention are described in detail below with reference to the attached drawing figures, which are incorporated by reference herein and wherein:

FIGS. 1A-1B depict an embodiment of APS device electronics schematic diagram embedded inside electric devices as power socket. In accordance with the illustrative embodiments; It has the ability to switch “on” and “off” any equipment connected to this power socket based on the human radiant Infrared energy and wireless energy.

FIG. 2 depicts an embodiment of a “stand alone” APS device in accordance with the illustrative embodiments; The APS device packed as small battery power device. It has the ability to sense the user radiant human Infrared energy and wireless energy and transmits a command over its wireless channel, to other devices to switch them “on” or “off” or to enable some function.

FIG. 3 depicts an embodiment of a “stand alone” APS device in accordance with the illustrative embodiments;

FIG. 4 depicts an embodiment of an APS devices inside different home or public appliances in accordance with the illustrative embodiments;

FIG. 5A depicts a relationship between wireless device on site, and the way that APS device process for automating features of an electronic device in accordance with the illustrative embodiments;

FIGS. 5B-5D and 6 illustrate waveforms according to various embodiments of the invention;

FIGS. 7-12 illustrate methods according to various embodiment of the invention; and

FIG. 13 illustrates a power regulator according to an embodiment of the invention.

### DETAILED DESCRIPTION

The disclosed embodiments APS device thereof are best understood by referring to 13 Figs of the drawings, figures numerate and corresponding parts of the various drawings. Other features' APS device of the disclosed embodiments will be or will become apparent to one of ordinary skill in the art upon examination of the following figures and detailed description. It is intended that all such additional features' APS device be included within the scope of the disclosed embodiments, and protected by the accompanying drawings. Further, the illustrated figures are only explanatory and not intended to assert or imply any limitation with regard to the environment, architecture, or process in which different embodiments may be implemented.

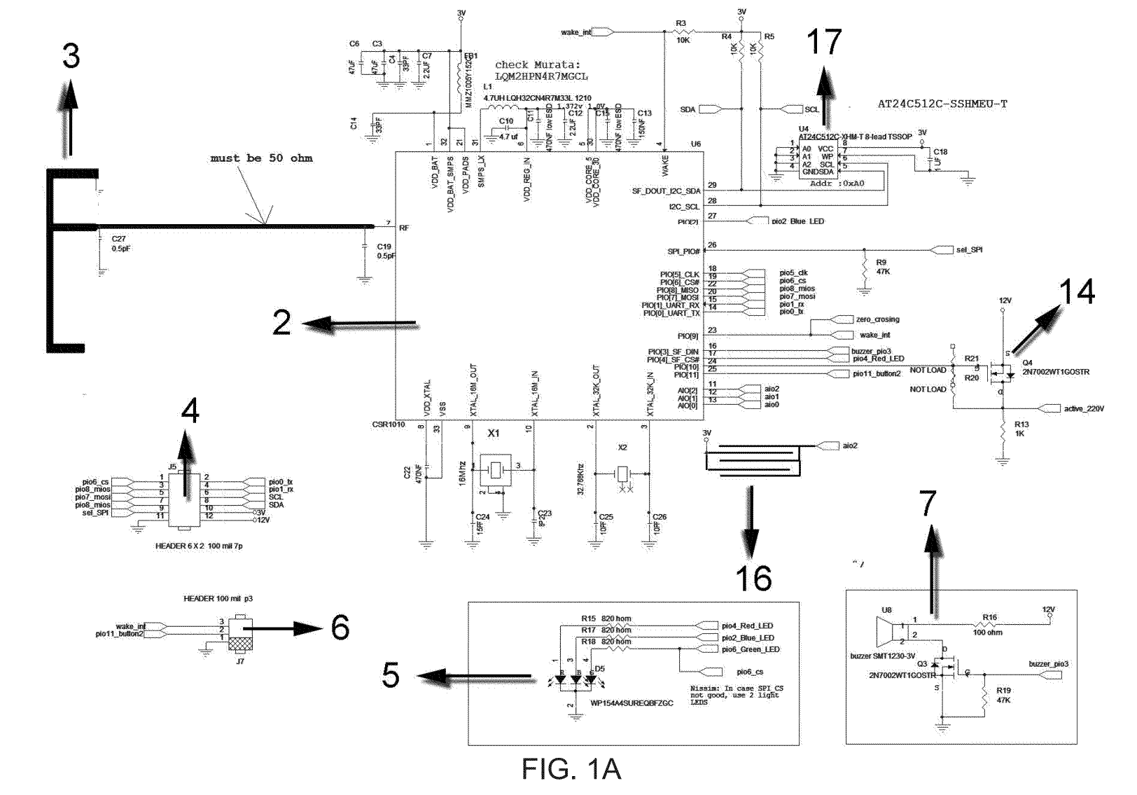

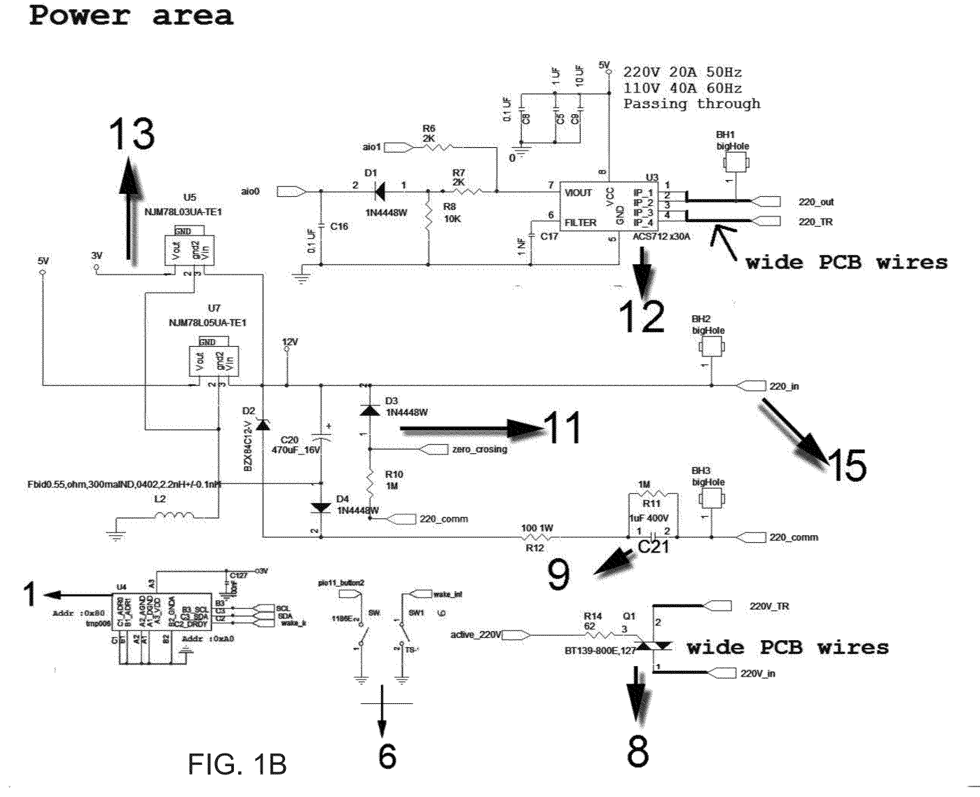

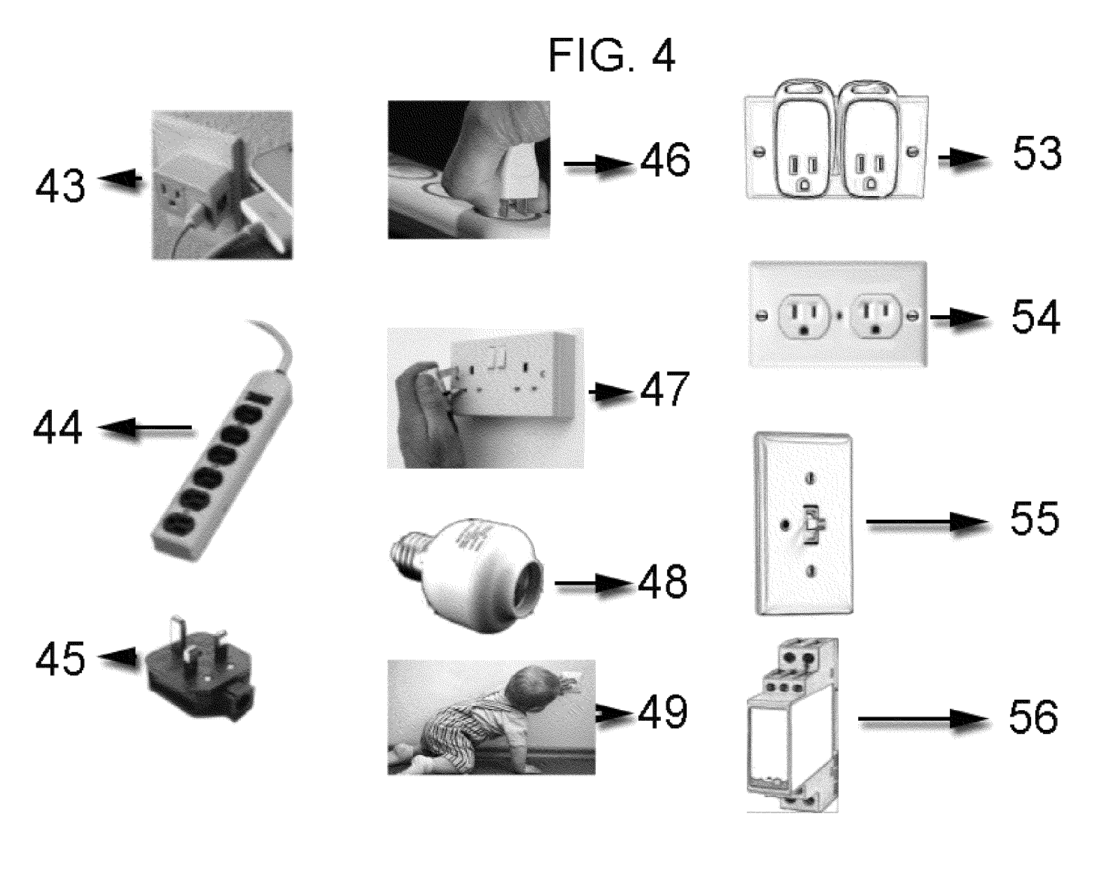

FIG. 1 depicts an embodiment APS device electrics schematic diagram embedded inside electric power devices as wall power socket, in which the illustrative embodiments may be implemented. In the depicted embodiment, a wall electric power socket or strip (FIG. 4 44) electric power socket. However, in other embodiments, an electric power socket may be, but is not limited to, a phone charger (FIG. 4 43), such as, but not limited to, an electric power cord connector (FIG. 4 45), electric wall air condition power socket (FIG. 4 47), light bulb device (FIG. 4 48), or a baby safe electric power socket (FIG. 4 49), an added device to electric power socket (FIG. 4 53). Additionally, in some embodiments, a more than one electric power socket (FIG. 4 54) may be, but is not limited to electric power switch (FIG. 4 55), and/or a Din Rail Mount Miniature Circuit Breaker inside home or office central box (FIG. 4 56).

In accordance with one embodiment, an electric power socket (FIG. 4 54) may include a heat sensor

(FIG. 1 1) for detecting the human radiant energy of a user. For example, in one embodiment, heat sensor (FIG. 1 1) may be an infrared (IR) sensor. An infrared sensor measures temperature using blackbody radiation (generally infrared) emitted from objects. Infrared sensor are non-contact sensor to describe the device's ability to measure temperature from a distance. As depicted in FIG. 1, in one embodiment, heat sensor (FIG. 1 1) may be utilized to detect the presence of user hand approaching the electric power socket (APS device). In other embodiments, e.g., the disclosed embodiments recognize certain advantage of the heat sensor over other types of sensors, such as, but not limited to, a motion sensor, for detecting the presence of a user hand nearby. For example, a motion sensor may not detect the presence of a user if the user is not moving fast his hand toward the APS device, and did not detect the proximity to the hand.

In accordance with one embodiment, heat sensor may communicate data with other components of an electric power socket (FIG. 1), such as, but not limited to, a MCU unit (FIG. 1 2), via I2C bus. I2C bus provides conductive pathways/traces to mechanically support and electrically connect the various components of an electric power socket for enabling data exchange.

Processing unit (FIG. 1 2), may be a set of one or more MCU processors/microprocessors or may be a multi-processor core, depending on the particular implementation. Processing unit (FIG. 1 2) serves to execute computer executable instructions, such as, but not limited to, computer executable instructions stored in memory component. In one embodiment, memory component may be volatile memory, such as, but not limited to, random access memory (FIG. 1 17), which stores currently executing computer instructions and/or other data associated with an MCU operating system, wireless settings, hardware device, and/or other software functions.

In accordance with one embodiment, processing unit (FIG. 1 2) may execute computer executable instructions for monitoring for the presence of user hand approaching using heat sensor (FIG. 1 1) for turning off an electric power socket in response to detecting the presence of user hand. In addition, in some embodiments, processing unit (FIG. 1 2) may execute computer executable instructions to provide an additional level of safety use of the electric power socket.

In addition, in some embodiments, the MCU unit (FIG. 1 2) detects the humidity or water by its analog input AIO[2], detection leakage on PCB grid of wires. When water presence, the grid (FIG. 1 16) gets water and the AIO sense voltage from the 3V. The MCU cut in this scenario the output power and send already over its inner buzzer and notify the user over its wireless channel.

In addition, in some embodiments, the disclosed embodiments may be utilized to conserve energy. For example, in one embodiment, an electric power socket may be configured to immediately enable a power saver feature associated with an electric power socket in response to detecting the absence of a user radiate energy on site. In other embodiments, an electric power socket may be configured to turn off the devices connected or associated with an electric power socket in response to detecting the absence of a user in order to conserve additional energy. Further, in some embodiments, an electric power socket may be configured to turn off, or place an electric power socket in sleep/standby mode in response to the user not returning, i.e., not detected by heat sensor or human radiated energy, within a specified period of time.

Additionally, in some embodiments, the disclosed embodiment may be utilized to automatically provide several convenience features to a user, including, but not limited to, disabling the output voltage power and current on the APS device output port. This function prevents the dangers of human get electric shock when plug in or plug out power cord (FIG. 4 46). When the IR sensor (FIG. 1 1) detects the proximity of the human hand the MCU (FIG. 4 46) gets the information from the IR sensor (FIG. 1 1) and cuts off the current and voltage (FIG. 1 15) output from APS device. The MCU (FIG. 1 2) controls the TRIAC (FIG. 1 8) to cut the power, and when the human hand is far away to switch on the power output from the APS device.

Further, in some embodiments, an electric power socket may have a current consumption monitor (FIG. 1 12) chip. All power flow out of the APS device is metered by this chip and reports to MCU over its AIO0 AIO1 ADC bus.

Further, in some embodiments, an electric power socket may be configured to maintain a log file that tracks the time and power consumption of the external devices connected to APS device, such as, but not limited to, log file stored in data storage unit (FIG. 1 17). For example, in one embodiment, a home or office users may utilize the log file to track the amount of energy is actually consumed. In some embodiments, an electric power socket may be configured to transmit the log file to a user smart phone or any other wireless network using it MCU (FIG. 1 2).

Further, in some embodiments, when there is special lower tariff's hours with reduce cost of using electric power. The APS device can be configured over its wireless channel to automatic start and stop the device attached to its base on the special lower tariff's hours. For example a washing machine, a boiler, heater and other heavy power consumers apparatus.

With reference to FIG. 1, an alternative embodiment is disclosed wherein the current flow out of the APS device is monitored and cap to maximum values. The current is monitored by (FIG. 1 12) chip.

In addition, in some embodiments, the MCU may trace the rising of the current of the new added external devices connected to the APS device. If the current is rising too fast, that may indicate of inrush current or sorted cord/circuit, and the MCU can cut off the power totally or increase output power very slowly. It also can report the situation to the user over its wireless channel. This function of limited current flow out prevents blue spark and extend the life of power socket and the life of the external devices connected to the APS device output.

Further, in some embodiments, APS device MCU (FIG. 1 2) as internal body temperature, non IR. In case that APS device is over heated, probably due to bad attached power wire connector or oxidizing or carbonized of its metal parts. The APS device MCU cuts the power flow out and prevents fire due to that cause. A report is sent by its wireless channel and an alert beep can be sound over its internal buzzer.

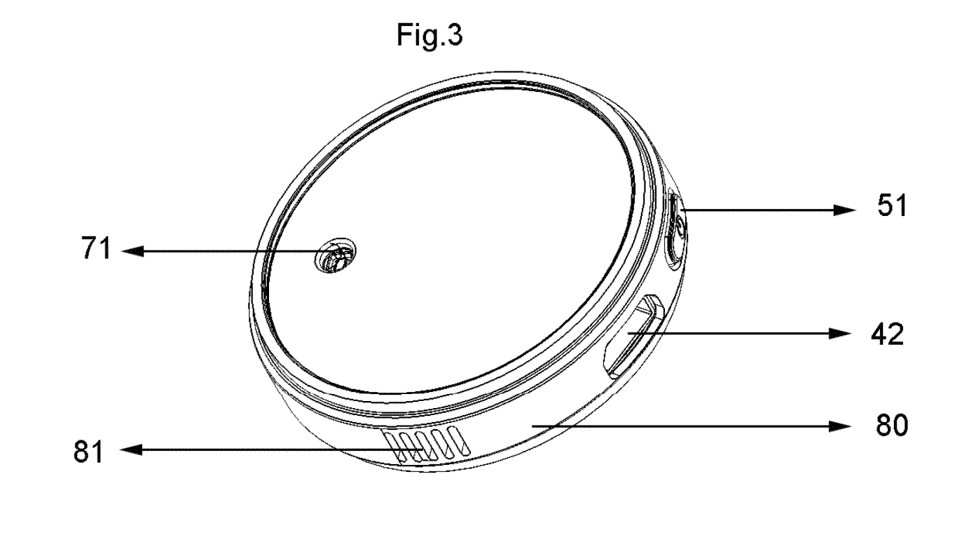

In addition, in some embodiments the APS device is utilized to detect the human radiant energy in accordance with the disclosed embodiments. External APS device sensor (FIG. 3) may comprise any suitable device capable of detecting the human radiant energy of a user, including, but not limited to, an infrared (IR) sensor (FIG. 3 71). In the disclosed embodiment, External APS device sensor (FIG. 3) communicates with other electric power socket via a wireless channel of MCU.

Further, In addition, in some embodiments the APS device utilizes a very low cost CSR1010 based APS system is introduced in APS device.

Further, in some embodiments the method design hardware and software are fully discussed. This system can also disclose how to control blue sparks suppression and prevention without the need to observe it, as at other prior arts.

The output current of the APS device is controlled through a TRIAC (FIG. 18). With a small current on the gate terminal, the TRIAC conducts the current that passes through the APS device. This way the MCU determines the APS device's power and controls the APS device's output current.

In low-end wall electric power socket, connection high power load produce high blue sparks which carbonized the metal parts and eventually heat the sockets and can cause fire.

The inrush startup current might be too high. As the current flows out increases, normally more than 1500 Watts can produce high blue sparks.

The above faults may cause the device fail to meet the safety standard. Moreover some non-linear inductive load may require continuous long lasting TRIAC fire pulses that will consume additional power. In this embodiments, we will introduce an APS application controlled by the CSR1010 MCU driving an AC high load through TRIAC.

This disclosed embodiments invention circuits will be provided in these embodiments:

1. A soft start algorithm to minimize the surge current at start up.
2. Soft switching when increasing or decreasing the APS device's output current.
3. The TRIAC fire pulse is modified to suppress the blue sparks brought by the not full sinusoidal current waveform. The measurement of blue sparks components and APS device power is done with an oscilloscope (TDS5054B with TCPA300/TCP305 together with the software—power measurement) and a digital power meter (WT210). The results show much better performance than normal control methods.
4. Output current control and robust control, which will be described in detail below.

In addition, in some embodiments the APS device hardwarean APS reference design is shown in FIG. 1, and a brief description of the circuit operation follows. The one PIO ports of the CSR1010 are used to generate the TRIAC (FIG. 1 8) drive waveform and control the output current flow out of the APS device. The gate negative trigger current of TRIAC BT139-800 is 35 mA. The port pins with (FIG. 1 14) transistor can provide sufficient trigger current to drive the TRIAC directly. Two keys (FIG. 1 6) are used to set the MCU and switch “on/off” the output current for the APS device. The MCU (FIG. 1 2) reads the keys' status using two PIO pins and then adjusts the APS device output current. A single port pin is used with a Key Pad Interrupt (KBI) (FIG. 1 11) function to synchronize to the AC line. This input port current that injects into the MCU is limited using a large value resistor.

APS with CSR1010 the MCU power supply (FIG. 1 13) current is taken directly from the mains supply. A capacitor, plus a resistor dropper circuit (FIG. 1 9), is used for voltage and current dropping. The current of the MCU power supply is limited by the size of the AC line dropper capacitor (FIG. 1 9). A high-voltage capacitor and a high-output current switching diode 1N4448 are needed to filter out the AC current and supply a DC current for the MCU. Between the VDD and the 1N4448, a 12 V Zener diode is used for the MCU voltage regulation. Testing shows that such a small and low cost MCU power supply circuit can provide enough stability.

3. System Design

In addition, in some embodiments describes the design features of the APS device control system. It is intended to understand the design basics and to use those features as a basis for developing APS device drive and to adapt it to any requirements.

The section is organized as follows: Output current control, TRIAC drive control, soft start, and blue sparks suppression.

3.1 Output current control APS device output current control is based on phase angle control. When the current passes zero crossing (FIG. 1 6), the TRIAC will not conduct until sufficient current triggers the gate terminal. The TRIAC will then continue conduction until next current zero crossing. The average power output of the APS device is proportional to the area of the current waveform. By controlling the firing angle of the TRIAC, we can determine the average power deliver to the load.

3.2 TRIAC drive control According to the data sheet of the BT139-800, the gate terminal turn on time is about 2 μs. For robust controlling, we set the TRIAC firing pulse to be 200 μs. Once conducted, the TRIAC will stay on until the next zero crossing. So the trigger current at gate terminal can be withdrawn. As we know, most loads are not pure impedance loads, as an inductive load. That is, the current of the load will lag the voltage. When the voltage reaches zero crossing, the current may continue to go for some degrees until cross its zero. If we fire the TRIAC near the zero voltage crossing point with a pulse as we used at other phase, the TRIAC may not be conducted as desired. Some method needs to be implemented to trigger the pulse of the TRIAC at those phases.

In this application, we apply a long fire pulse at the phase close to the Zero voltage Crossing (“ZVC”). For long fire pulse, the trigger pulse is set to be 400 μs, twice the fire pulse at other angle. 400 μs are suitable for current lagging not exceeding 7 degrees.

3.3 Startup Delay

The startup delay feature can reduce the startup surge current of the APS device. At start up, when charged with mains supply, there will be very high amplitude current among the APS device that may not comply with the limitation of IEC61000-3-2 standard. The startup delay stays at a output current point until it is stable and then shifts into the next level. Finally, the APS device will reach the lowest power level of the APS.

The soft switch algorithm allows controlling the output current smoothly when changing output currents.

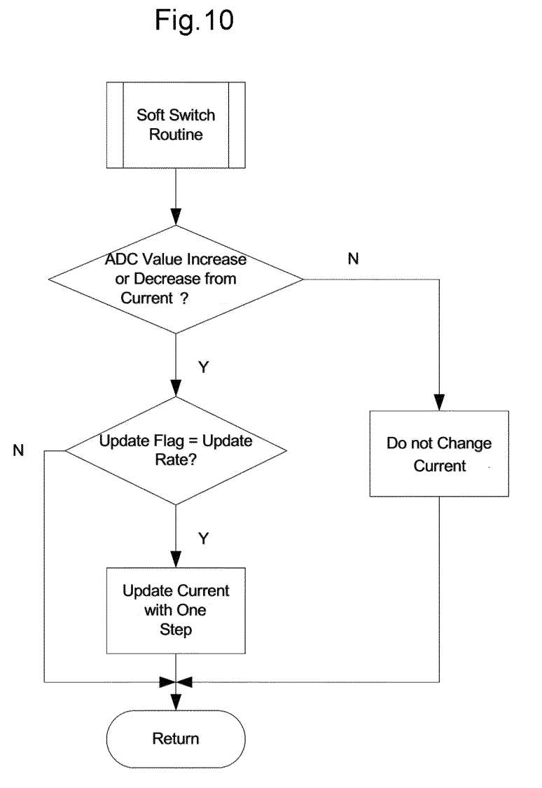

FIG. 10 shows the flow diagram of the soft start subroutine. By switching the output current, the soft switch scheme will prevent the current from changing dramatically. If the desired output current is faster or slower than current output current for more than one-step span, the software will get to the desired output current step by step and manage to smoothen the output current switching. Each step will hold on for an “update rate” period to stabilize the current by current sensing chip ACS712 (FIG. 1 12) and then move to next output current level. An experiment has shown that 128 steps from minimum to maximum output current are enough for this application. Such an algorithm provides robust control of the APS device and prolongs the life of the APS device and the electric power socket metal parts.

3.5 Blue Sparks Suppression

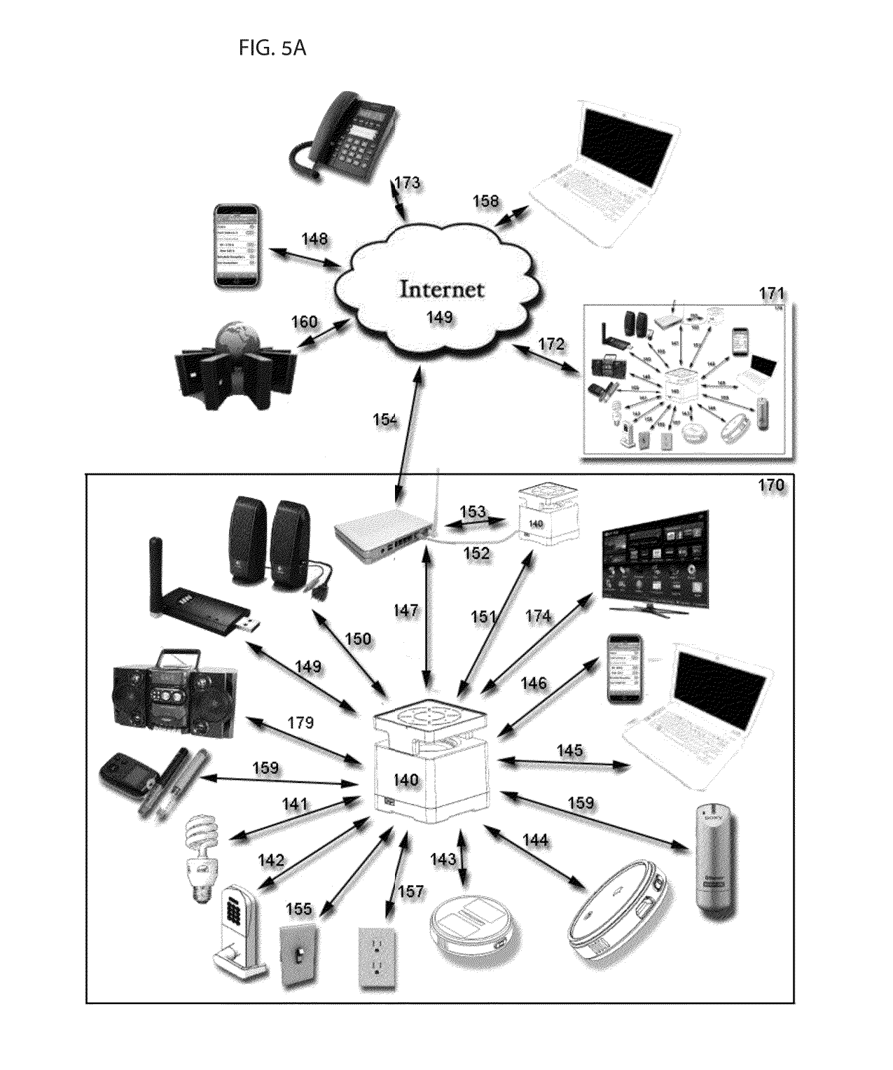

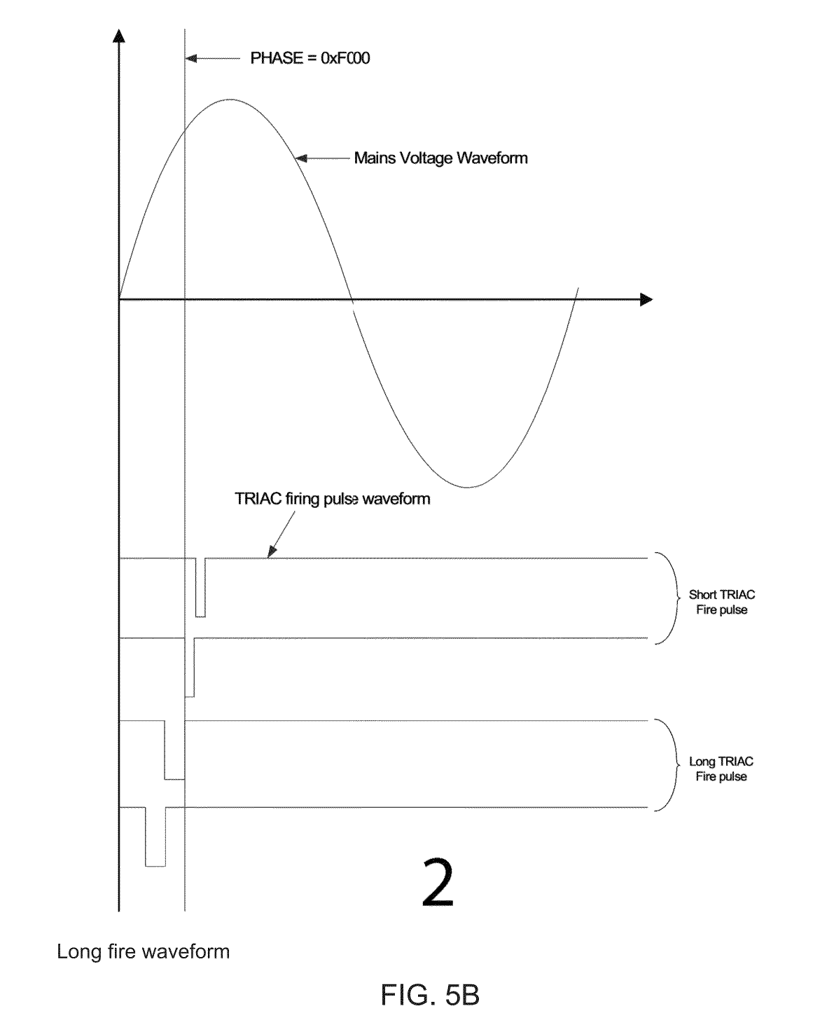

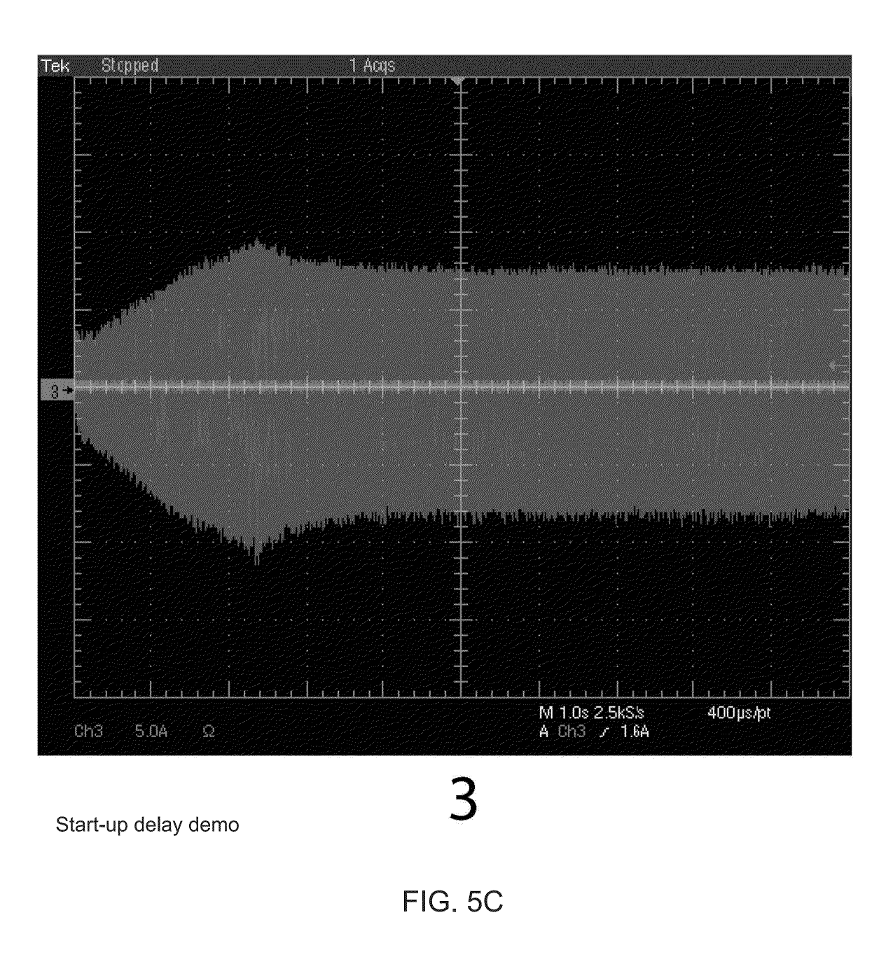

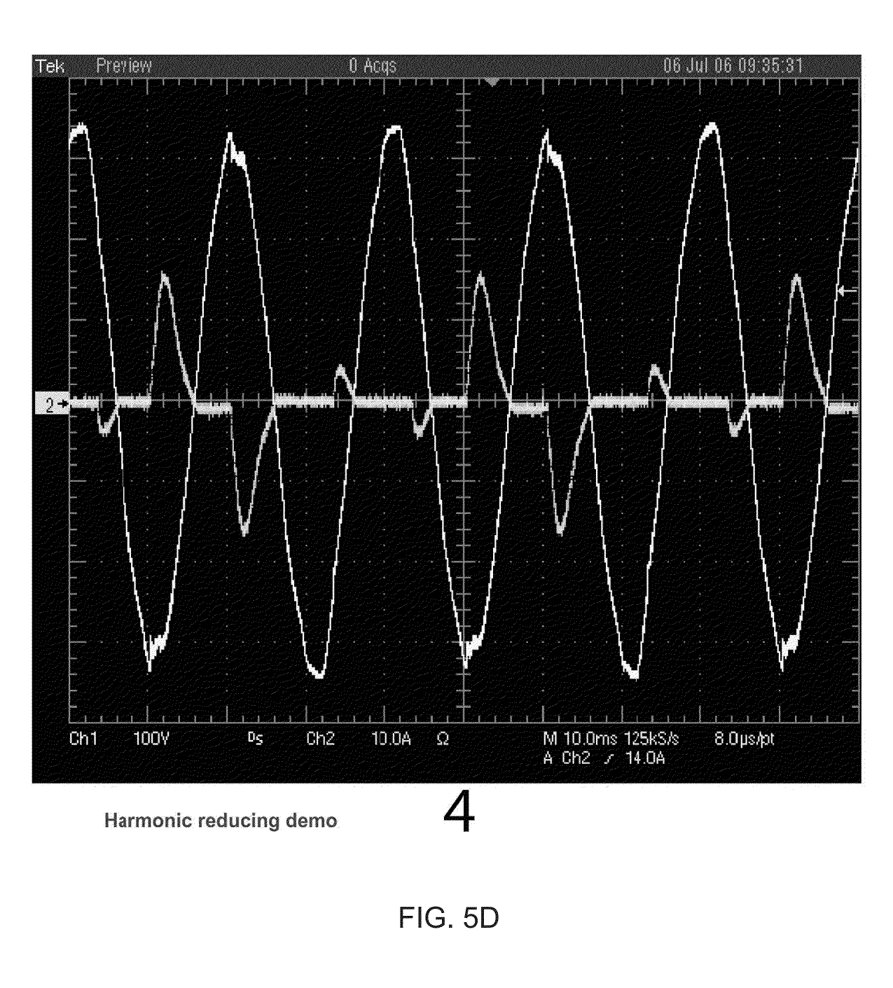

In addition, in some embodiments Blue sparks suppression is one of the most important features of the design. In this application, a phase control method. This method modulates the APS device current with one long phase trigger full wave and one short phase trigger full wave. The performance of the method is shown in (FIG. 5B-4). Channel 1 is the AC mains voltage waveform; channel 2 is the APS device current waveform.

4. APS software

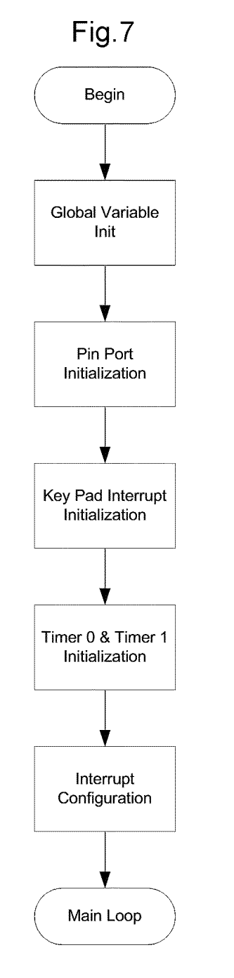

In this section, we will discuss the whole structure of the APS software. This software is developed for the CSR1010, and it will run on any simpler MCU with simple modifications. This MCU has Key Pad Interrupt functions that enable the mains zero voltage crossing detection (FIGS. 1-11). The two timers provide all the necessary timing control for the software. Timer 0 is used for TRIAC pulse generator. Timer 1 is configured as keys status sampler. The CSR1010 also features an internal oscillator and a small package. First, the MCU processes the initialization. A start up delay is added to ensure configuration operation and waits for the startup current to stabilize. The main function is ended with an endless while(1) loop.

The non-time critical events are blue sparks prevention waveform calculation, soft switch, and timer value conversion which all can be performed in the while(1) loop. Meanwhile, the zero voltage crossing detection, TRIAC pulse generation, and key status sampling, which require in time operation events, can be handled by the interrupt.

4.1 Main Loop

The main loop contains no time critical functions. When entering the main routine, function is processed to initialize global variables and PIO ports. Other hardware initialization of the MCU, such as keys interrupts, timer, interrupt, and on-chip RF Oscillator settings, are also implemented in this function.

After configuration, the main routine comes to the while(1) loop. Subroutine get_outputcurrent( ) processes the control of updating the global variable PHASE. PHASE in this software is used for Timer0 TRIAC fire time transferring. The get_outputcurrent( ) function is the combination of four subroutines: get_ADC( ), softswitch( ), harm_reduce( ) and phase2timer( ).

### Each

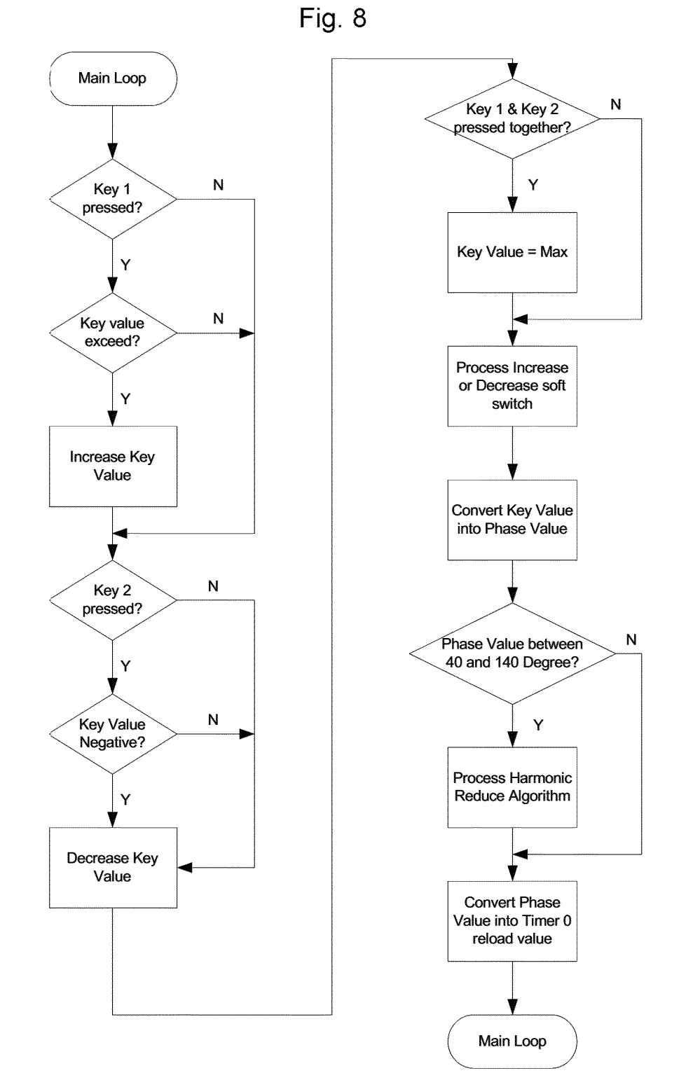

Subroutine performs a basic service as shown in the flow diagram in (FIG. 8).

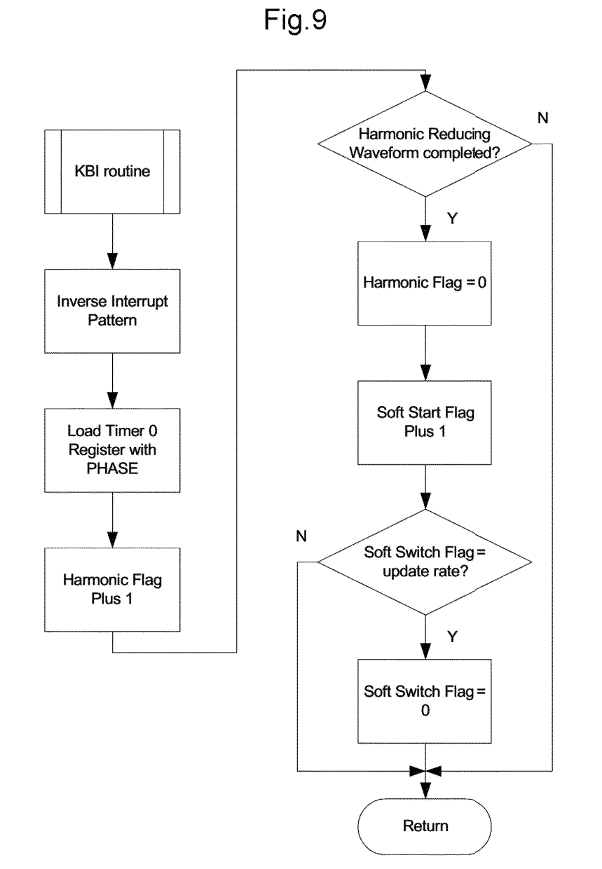

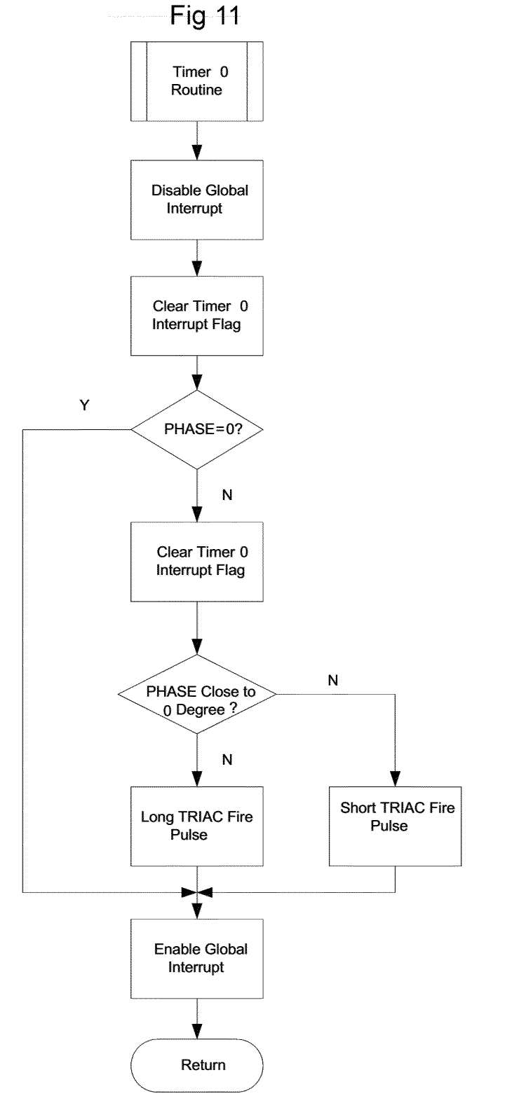

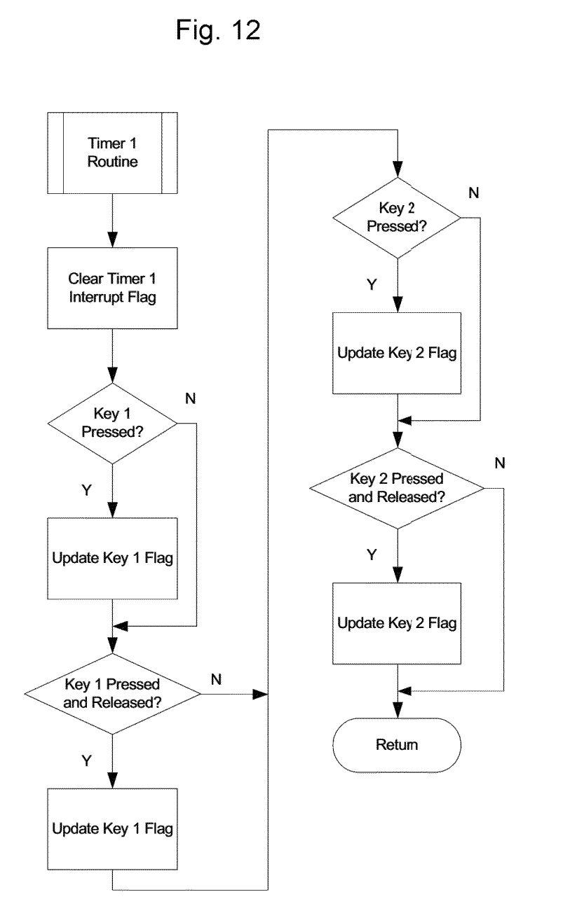

4.2 Keyboard interrupt (“KBI”) routine This embodiments detail the KBI interrupt subroutine because of its complexity and importance to the whole software. Other subroutines can be easily understood from the flow diagrams in (FIG. 9) (FIG. 10) (FIG. 11) (FIG. 12).

PIO[9] of the CSR1010 is configured as the KBI interrupt input pin. This pin is used also the zero voltage crossing detection.

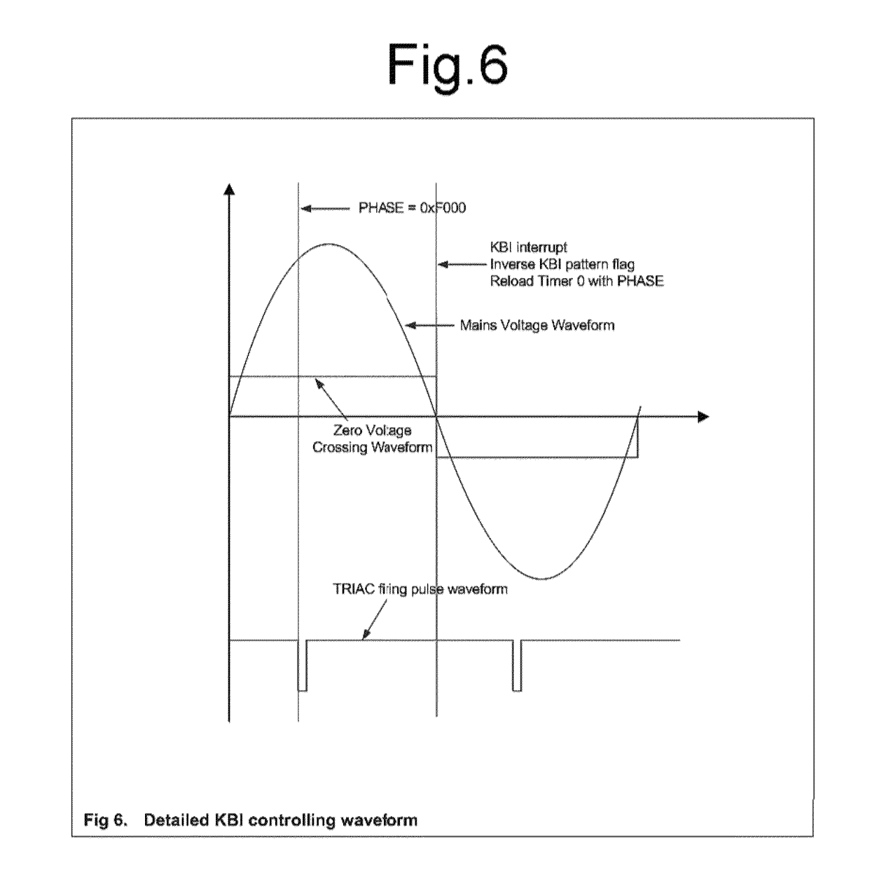

The main features of the KBI routine include: AC line synchronization, Timer 0 TRIAC fire angle loading, blue sparks suppressing waveform controlling, and soft switch update rate controlling. As shown in FIG. 6, the KBI subroutine is invoked when a falling or rising edge event occurs on PIO[9] Pin 23 of CSR1010. When entered, the first thing is to disable the global interrupt and not allowing other interrupts to take place while the KBI routine is running. In order to reenter KBI on the next zero voltage crossing point, inversing the CSR1010 KBI interrupt pattern is needed. That is, if current invoke event is falling edge (1 to 0), the KBI interrupt pattern should be set as 1 so that next rising edge (0 to 1) will invoke the KBI interrupt. For more detail please refer to the CSR1010 user manual.

Thanks to the flexible configuration of CSR1010 microcontroller, the software can be simple and robust. This saves time for the CPU to perform other functions and makes the whole software more synchronized to the AC mains.

In addition, in some embodiments conclusion In this application, we introduce a cost saving CSR1010 microcontroller based APS device system that can be a guide for other controlling designs like APS device in electric power socket, electric power plug, Control design for lamp or power tools design. The hardware implementation is simple and cost effective. The five most important system design points are discussed. They include: output current control, TRIAC drive control, startup delay, soft switch, and Blue sparks suppression. The software has been introduced with main loops and KBI interrupt routine. Results have shown good performance of the systems.

In addition, in some embodiments the APS schematic may include but not limited:
1. The APS device MCU CSR1010 (FIG. 1 2). This MCU can detect the current consumption and trigger the TRAIC. The information can be store inside the flash or transmit to other wireless devices and APS device over its wireless channel.
2. APS device PCB printed antenna (FIG. 1 3).
3. A connector to flash the MCU program (FIG. 1 4).
4. A RGB led (FIG. 1 5) to show in color the functions state of the APS device. for example Red light “on state”, Green light on “off” state, Blue Light on timer function etc.,
5. The APS device has two button (FIG. 1 6). One to select mode of personal, as toggle “on/off”, and other to wake the main MCU.
6. APS device buzzer (FIG. 1 7) is using to alert the user. The alert can be higher temperature on the APS device, higher current consumption on water detection by the MCU, and IR on/off function. Deferent on any event can have deferent alert beep.
7. The APS device TRAIC (FIG. 1 8) is switch the current flow output. The TRAIC used to soft power on, and soft power off to the attached external apart to APS device socket.
8. The APS device power supply cap (FIG. 1 9).
9. The APS device main voltage crossing schematics (FIG. 1 11).
10. The APS device current sensor (FIG. 1 12) detect all current flow out of the APS device.

The APS device has two power supply, 3V and 5V (FIG. 1 13).

The APS device has a 12V boost power to the TRIAC gate (FIG. 1 14).

The APS device 220_in (FIG. 1 15) is the main power in with 220V_comm220V and 110V.220_out is the APS device mains power output.

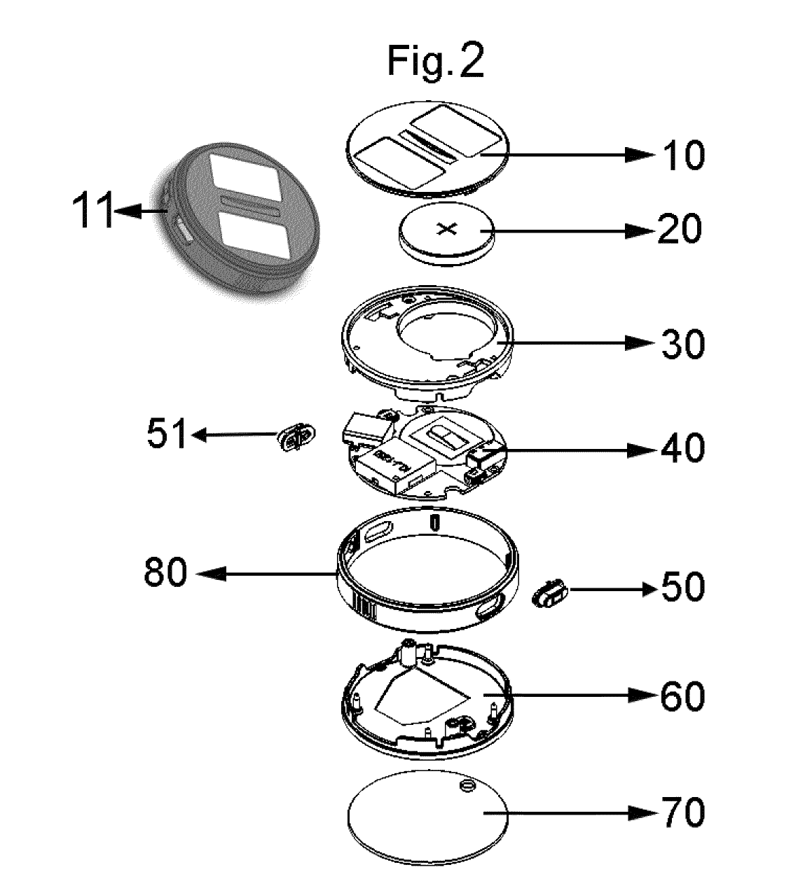

FIG. 2 shows, in pictorial APS device that detect human radiate energy and transmitted it output over it wireless channel. The APS device ring 80. The ring windows 81 to let the buzzer sound out. The APS device on/off button 50 51. The APS device label 11 QR code to automatic download the smart phone apps. The APS device security number 12 to secure pair with the smart phone apps. The APS device QR code and the security code prevent from others smart phone apps to control the APS device. The APS device's battery coin open cavity 21. APS device battery covers 10.

FIG. 3 shows, in pictorial all the APS device back side. This side sticks to windows or doors. The button functions selector 51. This button can select different mode of operation. For example: long pressure on button 51 moves the APS device to auto recognize state (or “pair”) with the smart phone apps. And add the smart phone unique identify number to a white list inside the APS device. This white list allows only the registered smart phone apps to command the A and to get data. Connector 42 is an extension port. It allows program the devices with different firmware; add external devices over digital and analog wires. It allows power the APS device from external power source, or to feed power to external devices. The APS device connector 42 supports server mode of operations, digital output PIO as 3V and GND. Digital input as PIO as 3V and GND. Digital busses as I2C and UART, to connect to more sensors as Gyro, digital compass, smoke, fire, humidity, gas, pressure, Co2, CO, pollution, sound, light, barometric, medical devices and more alike. This connector 42 enables to send command to external devices to activate them, for example door looker, room light, garage door opener. Or send and get data from external MCU and more alike. Windows 81 allows the buzzer sound to be heard outside the APS device. And 80 is the APS device cover ring. The APS device has an infrared remote human body temperature pick-up sensor 71, point outside of the windows. Around the sensor there is a sticker that sticks the APS device to wall, windows or doors. The sticker has hole for the infrared temperature sensor 71 path.

FIG. 5 The APS device invention serves as sensor for “Internet of Thing” concept in-sites as homes and public places. APS device invention apparatuses, methods and systems target to solve the main problem of sensing the human present on site.

At public or home places APS device (FIG. 5. 140) can wirelessly sense present nearby user's smart phone (FIG. 5. 148) by its MAC address or the user's keyfob (FIG. 5. 143) Bluetooth Smart MAC address. All senses MAC's are sent to Internet data base server (FIG. 5. 160) to retrieve command. The Command is used for authentication and operates nearby devices. The user recognition is done by bridging the information from the APS device (FIG. 5. 140) to Internet data base server (FIG. 5. 160), retrieves respond command and sends command to nearby devices as:

1. Door lock (FIG. 5. 142). The door Bluetooth Smart device in the range of the APS device does not need to recognize the user's smart phone (FIG. 5. 146) or use keyfob (FIG. 5 143). It's enough that the Internet data base server (FIG. 5. 160) recognizes the user to open the door (FIG. 5. 142) when the user is nearby. APS device (FIG. 5. 140) automatically closes the door when user is away. The “nearby” and “away” is recognized by User Bluetooth Smart device RSSI in the range of the APS devices.
2. Light bulb (FIG. 5 141). The bulb or its hosing is a Bluetooth Smart device in the range of the APS device, does not need to recognize the user smart phone (FIG. 5. 146) or use keyfob (FIG. 5 143) to be operated.
It's enough that the Internet data base server (FIG. 5. 160) recognizes the user to send command to light the bulb (FIG. 5. 141) based on day/night time when the user is nearby. APS device (FIG. 5. 140) automatically closes the light when user is away. The “nearby” and “away” is recognized by user Bluetooth Smart device RSSI in the range of the APS device. Light bulb (FIG. 5 141) can be commanded also to light from the user smart phone (FIG. 5. 146) or any other device that can communicate with APS device (FIG. 5. 140) For example user's PC (FIG. 5. 145), Wireless Microphone (FIG. 5. 159), wall electric switch (FIG. 5. 155), door handle (FIG. 5. 142), Internet web site (FIG. 5. 149), far smart phone (FIG. 5. 148), schedule data and time from Internet data base server (FIG. 5. 160), Bluetooth Smart light sensor that reports to APS device (FIG. 5 140).
3. In elevators, the APS device (FIG. 5. 140) can detect the presence of the user by its recognized Bluetooth Smart device, or smart phone in the range of the APS device and play its preferred songs using internal speaker or over external speakers (FIG. 5. 150). The preferred songs are retrieved using Internet data base server (FIG. 5. 160) based on the user “MAC's”.
4. At public places the APS device (FIG. 5 140) can detect the presence of the user by its recognized Bluetooth Smart device in the range of the APS device and advertise target advertisement or information over a near Electronic Billboards (FIG. 5. 174). For example, at airport terminal, when the user is recognized by its smart phone or Bluetooth Smart tag. Or at home displaying needed information to his TV display.
5. At airports terminals, shopping malls or any large public spaces, when the user is recognized by its smart phone or Bluetooth Smart tag information. The information on display (FIG. 5. 174) can be focused on the user's needs, as directions, and other information will not be shown.
When the user is in front of Airport terminal Billboards display and stops near one display (FIG. 5. 174). APS device (FIG. 5. 140) detects his nearby presence and displays the gate number, boarding time and directions. This information is pulled from Internet data base server (FIG. 5. 160).
6. At shopping malls, recognition of the user as described above can result of targeting advertisement based on the user's profile. If the user is defined at Internet data base server (FIG. 5. 160) that he likes to get new “laptop”, when he will step into shopping mall he will see on the nearby display an advertisement of the nearby shop with “laptops” with the prices and direction to the shop. When he will walk into the shop, he will see on the nearby display directions to the shelves with “laptops”. Also when APS device (FIG. 5 140) detects the user nearby presence, it can send SMS or any other electronic message to his smart phone (FIG. 5. 148).
7. The APS device (FIG. 5. 140) has a Bluetooth Smart profile that can work with Bluetooth Smart health (FIG. 5. 159) device. As Bluetooth Smart glucometer, Bluetooth Smart insulin pen, Bluetooth Smart heart rate monitor and many other.
8. The APS device (FIG. 5. 140) methods and systems working with medical devices as describe above is extremely important because most of Bluetooth Smart devices communicate only with smart phones. In many cases there is no smart phone around in range. Therefore a fix locating presence of APS device (FIG. 5. 140) will solve many needs.
9. Bluetooth Smart health (FIG. 5. 159) device as glucometer when reporting directly to APS device (FIG. 5. 140), the information is sent to Internet data base server (FIG. 5. 160) and a voice guide can be retrieved. This voice guide can be played on the internal speakers to inform the user how to monitor his pills or to use insulin pen. The insulin pen usage and dosage is also monitored by the APS device (FIG. 5 140), and the missed use can be reported to the user care taker. The user's pills cap also can be monitored, if it has a Bluetooth Smart tag attached, and the opening and closing will be reported to APS device (FIG. 5. 140) and to Internet data base server (FIG. 5. 160). Setting of timely consummation of the pills can be set by the care taker and forward to the pills' cap tag. Voice reminding can be played on pills consumption time.
10. Voice reminding can be played on the APS device (FIG. 5 140) inner speaker to remind user to consume pills at the right time. APS device (FIG. 5. 140) will command the pill cap tag.
11. APS device (FIG. 5. 140) supports BT HID profile with added invented function as bridging BT keyboard as in door handle to Internet data base server (FIG. 5. 160) and commands to open the door if user key is at the right code. Since the code is software server bases, it can be changed periodically. And can also enable usage of the same passkey code to multiple doors in public building or restrict some from remote.
12. APS device (FIG. 5. 140) supports BT HID profile with added invented functions as bridging the BT wall electric switch (FIG. 5. 155) to Internet data base server (FIG. 5. 160) and commands to open the light on the BT light bulb (FIG. 5. 141).
13. APS device (FIG. 5. 140) supports BT healththermometer profile with added invented functions as bridging the healththermometer to Internet data base server (FIG. 5. 160) and commands APS device (FIG. 5. 140) to play the thermometer level by human voice on the APS device (FIG. 5. 140) speaker.
14. APS device (FIG. 5. 140) supports BT infrared sensor thermometer profile with added invented function as bridging that data profile to Internet data base server (FIG. 5. 160). The Internet data base server (FIG. 5. 160) can use the APS device (FIG. 5. 140) to generate many responds due to this event, and playing a warning message on APS device (FIG. 5. 140). In the case that BT tag monitors a baby at night, the Internet data base server (FIG. 5. 160) sends electronic message to user smart phone.
15. APS device (FIG. 5. 140) can switch on and off, wall electric power (FIG. 5. 157) based on profile defined by the user on Internet data base server (FIG. 5. 160). It can also monitor power consumption and reports that. Since the presence of the user in the site is also monitored (by user's BT device RSSI) the wall electric power (FIG. 5. 157) can switch on and off automatically by APS device (FIG. 5. 140) to preserve power.
16. APS device (FIG. 5. 140) has an internet link and with Internet data base server (FIG. 5. 160) it can close or open or calibrate any environmental controlled devices in the house. As air condition or heater.
17. APS device (FIG. 5. 140) links to any BT sensors in the house, as smoke tag, fire tag, alarm tag, gas detection tag etc, and report their events' activities to Internet data base server (FIG. 5. 160). The Internet data base server (FIG. 5. 160) can generate events as electronic messages to smart phones (FIG. 5. 148) or to PCs (FIG. 5. 158), voice messages to speakers (FIG. 5. 150), phone calls (FIG. 5. 173) in the site (FIG. 5. 170) or at any other site (FIG. 5. 172) (FIG. 5. 171) or hosting APS device (FIG. 5. 140) too.
18. APS device (FIG. 5. 140) can link to other local APS devices (FIG. 5. 153) by its Wi-Fi functions as Router and Station in the same time. This allows the APS devices (FIG. 5. 140) to cover large areas of Bluetooth Smart devices in the range of any available APS device.
19. Since All APS devices (FIG. 5. 140) and (FIG. 5. 171) are linked to same Internet data base server (FIG. 5. 160). Events that the Internet data base server (FIG. 5. 160) detect on one APS device (FIG. 5. 140) site (FIG. 5 170) can generate responds also on other site of APS device (FIG. 5 171).
20. The APS device (FIG. 5. 140) with its Internet data base server (FIG. 5. 160) can generate wide voice messages as needed in case of fire in public places. Or flashing light at home for hearing impair.
21. APS device (FIG. 5. 140) located in an hospital room (FIG. 5. 170), monitors health BT tag, as BT patient heart rate, can report alarm on other sites as nurses' station (FIG. 5 171).
22. Linked APS device (FIG. 5. 140) to other APS devices (FIG. 5. 140) on long public corridors and rooms, can detect people movements and locations. As needed in some hospitals, Airport terminals or shopping malls.
23. The APS device (FIG. 5. 140) supports Bluetooth Smart devices and Bluetooth Classic. With this ability it can detects a BT microphone (FIG. 5. 159) and bridge that to search recognition internet server to carry user voice command at local BT device. As “light on”. “Switch to sports channel” on TV.
24. The APS device (FIG. 5. 140) can connect also to tag (FIG. 5. 144) with port to wire output devices. In this mode the APS device (FIG. 5. 140) can control devices that do not have Bluetooth Smart capabilities. As garage door.
25. The APS device (FIG. 5. 140) can connects also to tag (FIG. 5. 144) with port to wire input devices. In this mode the APS device (FIG. 5. 140) can sense the environment without the link of Bluetooth Smart capabilities. To tag (FIG. 5. 144) wires input can be connected to house none BT temperature sensors.
26. The user's local in-site PC (FIG. 5. 144) is also linked to APS device. And since the APS device (FIG. 5. 140) expose Wi-Fi playing capabilities, as AirPlay protocols, it bridges playing music sent by PC (FIG. 5. 145) iTunes and iPhone to Home multimedia entertain system (FIG. 5. 179), or Speakers (FIG. 5. 150).
27. Since APS device (FIG. 5. 140) exposes also legacy Bluetooth Classic, it imitates Bluetooth Classic headset and bridge music in this channel to Home multimedia entertain system (FIG. 5. 179), or Speakers (FIG. 5. 150).
28. The user's local in-site PC (FIG. 5. 145) and its smart phone (FIG. 5. 146) is also linked to APS device. And since the APS device (FIG. 5. 140) is linked with Internet data base server (FIG. 5. 160) with web interface, it bridges requests to listen to internet radio and retrieves music from internet radio stations and send it to its local speaker, Home multimedia entertain system (FIG. 5. 179) or Speakers (FIG. 5. 150).
29. In cases there is no Wi-Fi connection to internet router, it can use one of its open USB port to host cellular link (FIG. 5. 149) to the internet.

Accordingly, embodiments of the disclosed invention include a human radiant energy sensing control apparatus (e.g., an electric power socket with an internal and/or external heat sensor) and a method for automating features of the an electric power socket based on detection of a user's human radiant energy. For example, in one embodiment, an electric power socket is disclosed having a heat sensing mechanism for detecting the human radiant energy of a user. In addition, the an electric power socket includes a data storage component for storing computer executable instructions and a processing unit for executing the computer executable instructions for enabling a user to configure one or more functions associated with the an electric power socket that are triggered in response to detecting the presence or absence of the user within the proximity of the an electric power socket using the heat sensing mechanism.

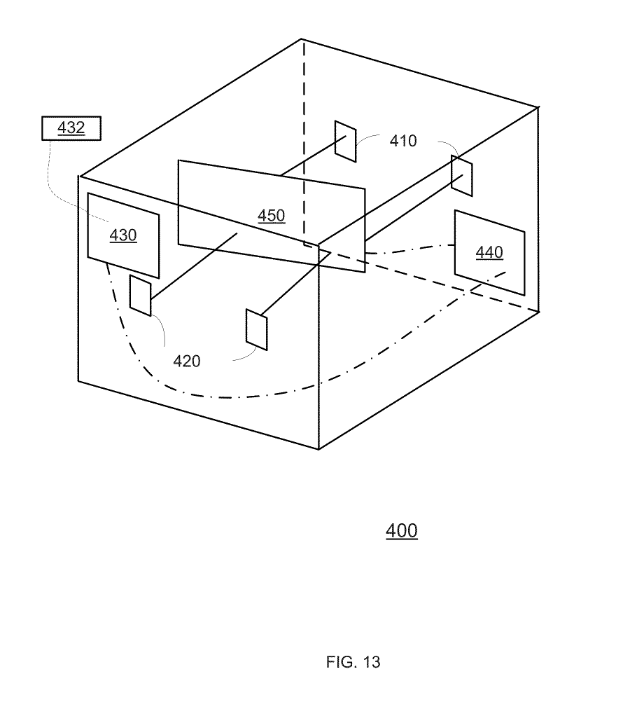

FIG. 13 may illustrates a power regulator 400 according to an embodiment of the invention.

The power regulator that may include a power input 410 for receiving input power; a power output 420 for outputting output power; a sensing module 430 for sensing an occurrence of a first event; and a controller 440 that may be configured to control a provision of input power to the power output in response to the occurrence of the first event. The controller 440 may control a power control unit 450 that is coupled between the power input 410 and the power output 420. The power control unit 450 may be a switch (for turning power on or off) or a more sophisticated unit (current and/or voltage limiters) that may limit electrical parameters (current level, current change rate, voltage level, voltage change rate) of the power supplied to the power output.

The sensing module 430 may include a proximity sensor 432 and the first event may be an absence of any person within a first predefined range from to the power regulator. The controller 440 may be configured to reduce the output power when the first event occurs. FIGS. 2 and 3 illustrate an APD device that includes the sensing module 430 and the controller.

As will be appreciated by one skilled in the art, certain aspects of the disclosed embodiments may be embodied as a system, method, or computer program product. In addition, the disclosed embodiments including, but not limited to, the disclosed modules may be implemented entirely with hardware or as a software embodiment (including firmware, resident software, micro-code, etc.) or an embodiment combining software and hardware aspects. Furthermore, the disclosed embodiments may take the form of a computer program product embodied in any tangible medium of expression having computer-usable program code embodied in the medium.

The disclosed embodiments are described above with reference to flowchart illustrations, sequence diagrams, and/or block diagrams. Each block of the flowchart illustrations and/or block diagrams, and combinations of blocks in the flowchart illustrations and/or block diagrams, may be implemented by computer program instructions. In addition, the flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which may include one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Additionally, computer program instructions for executing the disclosed embodiments may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks. The computer program instructions may also be loaded onto a data processing apparatus to cause a series of operational steps to be performed on the an electric power socket to produce a computer implemented process such that the instructions which execute on the an electric power socket provide processes for implementing the functions/acts specified in the flowchart and/or block diagram block or blocks.

The terminology used herein is for describing particular embodiments only and is not intended to be limiting of the invention. As used herein, the singular forms “a”, “an” and “the” are intended to include the plural forms as well, unless the context clearly indicates otherwise. It will be further understood that the terms “comprise” and/or “comprising,” when used in this specification and/or the claims, specify the presence of stated features, integers, steps, operations, elements, and/or components, but do not preclude the presence or addition of one or more other features, integers, steps, operations, elements, components, and/or groups thereof.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The disclosed embodiments were chosen to explain the principles of the invention and the practical application, and to enable others of ordinary skill in the art to understand the invention for various embodiments with various modifications as are suited to the particular use contemplated.

We claim:

1. A power regulator, comprising:
a power input for receiving input power;
a power output for outputting output power;
a sensing module for sensing an occurrence of a first event; and
a controller that is configured to control a provision of input power to the power output in response to the occurrence of the first event;
wherein the sensing module comprises a proximity sensor and the first event is an absence of any person within a first predefined range from to the power regulator; and
wherein the controller is configured to reduce the output power when the first event occurs.

2. The power regulator according to claim 1 wherein the proximity module is configured to sense radiation emitted from a person or a device of the person.

3. The power regulator according to claim 1 wherein the sensing module is further configured to sense an occurrence of a second event, and the controller is configured to control the provision of input power to the power output in response to the occurrence of the second event that differs from the first event.

4. The power regulator according to claim 3 wherein the sensing module comprises a current monitor and wherein the second event is a change in an electrical parameter of an output current provided through the power output that exceeds a predefined current change threshold.

5. The power regulator according to claim 4 wherein the electrical parameter is an increment rate of the output current.

6. The power regulator according to claim 3 wherein the sensing module comprises a thermal monitor and wherein the second event is an increase of a temperature of the power regulator that exceeds a predefined temperature threshold.

7. The power regulator according to claim 3 wherein the sensing module comprises a power monitor for monitoring a consumption of the output power to provide power monitoring results; wherein the power regulator comprises a transceiver for transmitting information about the power monitoring results.

8. The power regulator according to claim 3 wherein the sensing module comprises a humidity monitor for monitoring a humidity in proximity to the power output; wherein the second event is a humidity that exceeds a predefined level.

9. The power regulator according to claim 1 wherein the controller is configured to limit an increment rate of the output current during a powering up of a device that is coupled to the power output.

10. The power regulator according to claim 1 wherein the controller is configured to suppress sparks by modulating the output power.

11. The power regulator according to claim 1 comprising a transceiver for receiving instructions that define the first event.
